(19) United States
(12) Patent Application Publication
(10) Pub. No.: US 2024/0175206 A1
(43) Pub. Date: May 30, 2024

(54) METHOD FOR PRODUCING PRODUCTS BASED ON NON-WOODY BIOMASS AS RAW MATERIAL

(71) Applicant: TECHNISCHE UNIVERSITÄT WIEN, Vienna (AT)

(72) Inventors: Anton FRIEDL, Vienna (AT); Maximilian LEHR, Vienna (AT); Martin MILTNER, Maria Anzbach (AT); Walter WUKOVITS, Draßburg (AT)

(21) Appl. No.: 18/270,207

(22) PCT Filed: Dec. 29, 2021
(86) PCT No.: PCT/EP2021/087769

§ 371 Date: Jun. 29, 2023

(30) Foreign Application Priority Data
Dec. 29, 2020 (EP) 20217522.0

(51) Int. Cl. D21C 3/20; A23K 10/32; D21C 3/26; D21C 9/02; D21C 9/08

(52) U.S. Cl. CPC D21C 3/20; A23K 10/32; D21C 3/266; D21C 9/02; D21C 9/086

(57) ABSTRACT

The invention relates to a method for producing products based on non-woody biomass as raw material, characterised in that non-woody biomass which contains cellulose, hemicelluloses and lignin and is in the form of particles is subjected to an extraction treatment with an extractant which comprises one or more organic solvents in an organic aqueous mixture of the solvent or solvents with water, wherein the content of fatty acids in the particles is reduced by the extraction treatment of the particles with the solvent by at least 70%, measured as hexanal content in wt. % after accelerated ageing for 72 hours at 90° C., but the content of cellulose, hemicelluloses and lignin is substantially preserved in this extraction treatment.

The invention relates to methods for producing products based on non-woody biomass, in particular methods for the pre-treatment of non-woody biomass.

Non-woody biomass as a raw material for industrial processing into products (such as fibreboard or cardboard) contains—in addition to the main components cellulose, hemicelluloses and lignin—many different substances of low and high molecular weight, such as fatty acids, phenols, alcohols, aldehydes, pinenes, terpenoids and terpenes. These substances are grouped together as so-called extraction substances (or extractives) because they can be extracted from non-woody biomass using hot water and/or organic solvents (Boutekedjiret et al., in: Alternative Solvents for Natural Products Extraction (2014), Chemat et al. (Eds), 205-219; Martins et al., J. Mol. Liq. 241 (2017), 996-1002; Hippenstiel et al, Arch. Geflügelk. 75 (2011), 226-234; Hatanaka, Food Rev. 12 (1996), 303-350). Many of these extractives are “organoleptically relevant substances”, as they may lead to odour and taste interactions and negative effects in products based on non-woody biomass with the environment relevant to the particular end use (for example, foodstuffs in the case of packaging board or indoor air in the case of fibreboard). In addition to extractives, which, as volatile hydrocarbons, naturally exhibit characteristic odours (e.g. terpenes), aldehydes (very particularly hexanal), which are formed by autocatalytic oxidation of the fatty acids naturally occurring in the non-woody biomass, especially linoleic acid, are primarily responsible for this (Hatanaka, 1996).

Furthermore—due to these extractives—particles from non-woody biomass can coagulate to form sticky particles during processing, this being intensified by the fats and waxes that also occur naturally in the non-woody biomass. These aggregates may also cause disruptive effects on the surface of the manufactured products (such as cardboard or special papers), which may subsequently cause problems in the further processing of the products (e.g. printing). These substances may also have a disruptive effect on the production process by causing deposits on machine parts, rollers and clothing parts, etc.

Currently, fatty acids are not removed from particles for particle-based products, such as cardboard or fibreboard. Instead, the auto-oxidation of these fatty acids is inhibited or delayed by binding the heavy metal ions acting as catalysts in the products made from particles of non-woody biomass by adding complexing agents such as ethylenediaminetetraacetic acid (EDTA) or diethylenetriaminepentaacetic acid (DTPA). However, EDTA and its metal complexing agents are only poorly and slowly degradable in wastewater treatment and are therefore now considered ecologically questionable, which poses increasingly greater problems especially for wastewater from production plants for products based on non-woody biomass.

Other methods that have been described to improve organoleptic properties may use bleaching, delignifying, oxidising or reducing chemicals.

DE 10 2009 046 127 A1 describes a method for producing wood fibre materials. WO/0061858 A1 relates to a method for separating lignocellulosic biomass into lignin, hemicellulose and cellulose. U.S. Pat. No. 5,698,667 A discloses a pre-treatment of a lignin-containing cellulosic material by extraction with an organic solvent (e.g. acetone). DE 10 2014 114 921 A1 relates to a method for producing an “emission-reduced” solid wood product or an “emission-reduced” wood-containing starting material, in which treatment is carried out with a “buffer solution” having a pH of ≥6, precisely in order to “reduce” the emission (substantially of VOCs), however cellulose, hemicellulose and lignin are seemingly not fundamentally obtained and it is not disclosed to what extent the content of fatty acids can be reduced with this method. According to WO 2006/032267 A1, solid wood or wood particles are treated in such a way that the fatty acid esters contained therein are “inhibited, cleaved or oxidised”, but not extracted. WO 93/20279 A1 discloses the treatment of cellulose pulp (i.e. not wood particles) with organic solvents, which are to be separated again following this treatment. WO 2020/000008 A1 discloses the production of lignin particles. WO 00/34568 A1 relates to a method for producing chemical pulp from wood chips, wherein hemicellulose and lignin are separated. EP 2 138 528 A1 relates to a method for producing a cellulose material with reduced wood extractive content. DE 10 2016 219 719B3 discloses a method for producing cellulose, hemicellulose and lignin. EP 2 356 977 A1 relates to the use of Gleditsia wood extracts for the treatment of cellulite.

It is therefore an object of the present invention to reduce the content of releasable odour- and taste-active aldehydes in products based on non-woody biomass, such as cardboard or fibreboard, by auto-oxidation of fatty acids naturally occurring in the non-woody biomass. The objective is to do this without the use or addition of complexing agents.

A further object of the present invention is to significantly improve the organoleptic properties of particles based on non-woody biomass, as well as aged particles produced by this method, so that the products produced therewith have no or only low odour, even without the use or addition of bleaching, delignifying, oxidising or reducing chemicals. In particular, the method according to the invention is intended to prevent, after ageing of the particles of non-woody biomass (up to 6 months), any undesirable odour and taste changes occurring during the course of this ageing in the foodstuffs coming into contact therewith.

Lastly, a preferred object of the present invention is to remove further ingredients from particles based on non-woody biomass which are undesirable in the intended product, for example terpenes.

Accordingly, the present invention relates to a method for producing products based on non-woody biomass as raw material, in which non-woody biomass which contains cellulose, hemicelluloses and lignin and is in the form of particles is subjected to an extraction treatment with an extractant comprising one or more organic solvents in an organic aqueous mixture of the solvent or solvents with water, wherein the content of fatty acids in the particles is reduced by the extraction treatment of the particles with the extractant by at least 70%, measured as hexanal content in wt. % after accelerated ageing 2 hours at 90° C., but the content of cellulose, hemicelluloses and lignin is substantially preserved in this extraction treatment.

As has been shown in the course of the present invention, a significant improvement of the organoleptic properties of particles based on non-woody biomass can be achieved with the extraction of organoleptically questionable substances from the raw materials according to the invention, without the addition of complexing agents, but by removing potential aldehyde sources, first and foremost fatty acids. However, it is known that fatty acids as a source of aldehyde, and subsequently as a source of organoleptic impairments of these particles, can only be satisfactorily quantified by measurement with great effort. According to the invention, the hexanal content of the particles after ageing was therefore used to assess the extraction success. This has proven to be a reliable parameter for the organoleptic properties of the products to be produced from the raw material, such as (special) paper, cardboard, fibreboard, etc., which correlates excellently with the (very time-consuming) traditional ageing tests (in this regard see the investigations and proofs in the example section, below).

It has been found that the method according to the invention can extract most of the fatty acids and other interfering substances (pinenes, terpenoids and terpenes, etc.) without significantly adversely affecting the non-woody biomass substance (cellulose, hemicelluloses and lignin). Although any improvement in the removal of fatty acids from the raw material based on non-woody biomass is advantageous, a significant reduction of at least 70% is readily achievable for large-scale suitable economic use with the present method. Preferably, however, the treatment according to the invention is selected such that the desired reduction is in any case achieved by it, and thus a reduction of at least 70%, preferably of at least 90%, in particular of at least 95%, is achieved. Accordingly, the conditions to be applied according to the invention can then be selected, for example on the basis of the nature of the non-woody biomass or the extractant, in such a way that the hexanal reduction according to the invention is obtained in any case. In this way, maximum values in absolute hexanal contents can also preferably be set. Although particles with a hexanal content of 2 mg/kg dry material (DM) can also be used for certain applications, absolute values of below 1 mg/kgDM are preferred. In the particularly strict guidelines applied in the course of the examples of the present invention, a hexanal content of 0.5 mg/kgDM hexanal (based on dry non-woody biomass) was marked as an empirically determined value, below which organoleptic impairments are no longer sensorially perceptible according to experience. Accordingly, a preferred embodiment of the method according to the invention relates to an extraction of the particles based on non-woody biomass to a hexanal content of 0.5 mg/kgDM or below. For hexanal contents of the particles>0.5 mg/kgDM, it was found that the risk of organoleptic impairment of the particles also increased with increasing hexanal content.

For the purposes of the present invention, the hexanal content in doubt can be determined by headspace gas chromatography (HS-GC) by filling about 0.2 g of air-dried non-woody biomass particles (90-95 wt. % dry substance content (DSC)) into a headspace vial. In these vials, the non-woody biomass particles must then be aged-sealed at room temperature (about 20° C.) for six months to oxidise the fatty acids to hexanal. Since this takes a very long time, and thus does not allow a timely assessment of the extraction success, the determination of the hexanal content according to the present invention is carried out via accelerated ageing following DIN ISO 5630-2. Thus, the hexanal content was determined in the tests in the example section (unless explicitly stated otherwise); this also authoritative in case of doubt 15 procedure is for the determination of the hexanal content for the purposes of the present invention. Here, the non-woody biomass particles are sealed in HS-GC vials, aged at 90° C. for 72 hours, and subsequently the hexanal content is determined by HS-GC.

Preferably, the particles are less than 2 mm in size, preferably in the form of fibres, swarf or mixtures thereof. This particle characteristic (as “particle size”) is defined according to the National Renewable Energy Laboratory (NREL) Laboratory Analytical Procedure (LAP) NREL/TP-510-42620 “Preparation of Samples for Compositional Analysis”, to which NREL LAP NREL/TP-510-42619 “Determination of Extractives in Biomass” also refers. Accordingly, the particle characteristic of particle size is formulated at the sieve mesh size (2 mm) of the granulator for sample preparation.

The particles based on non-woody biomass used according to the invention are preferably in the form of fibres, swarf or mixtures thereof. This limitation of the particle size to 2 mm, as also specified in NREL method NREL/TP-510-42620, brings with it the great advantage that, in addition to the relatively easily accessible resin channels, the comparatively difficult-to-access parenchyma cells, where the fatty acids are located, can also be easily reached extractively (Lehr et al., Removal of wood extractives as pulp (pre-) treatment: a technological review (2021), SN Applied Sciences 3:886).

According to a preferred embodiment, the particles are non-woody biomass defibrated by mechanical and/or thermal and/or chemical digestion, in particular non-woody biomass fibres with average fibre lengths between 0.5 and 2 mm and average fibre diameters between 10 and 50 μm. Average fibre length and average fibre diameter refer to the length average determined by optical measurement of the suspended fibres. This optical measurement usually leads to uniform results (independently of the chosen methodology and analysis device), but the devices PulpEye (http://www.pulpeye.com/products/pulpeye/) and especially MorFi Fiber Analyzer (http://www.tech-pap.com/fiber-and-shive-analyzer-morfi-neo, lab-de vice, 31.html), have proven to be particularly suitable.

The amount of organic compounds that can be extracted by the method according to the invention varies depending on the type of non-woody biomass and part of the plants from which the particles are obtained. For example, such organic compounds often vary in the range of 20 to 40% in bark, often between 15 and 20 in olive bush cuttings, often between 5 to 10% in grapevine bush cuttings; for example, proportions of 16% and 10% for switchgrass, 25% and 16% for fescue grass, 17% and 5% for corn stover, and 21% and 13% for red maple bark have been reported (Royer et al., J. Food Res. 1 (2012), 8-45; Routa et al, Nat. Res. Bioecon. Stud. 73 (2017), Nat. Res. Inst. (FI); Cavalaglio et al., Sustainability 12 (2020), 6678; Thammasouk et al., J. Agric. Food Chem. 45 (1997), 437-443). Accordingly, depending on the type and species of non-woody biomass, the extractive content can range from a single-digit percentage range to several 10%, i.e. usually from 1 to 50%, mostly from 5 to 40% (these figures also refer to wt. %).

According to the invention, all non-woody biomasses containing cellulose, hemicelluloses and lignin and with a content of organoleptic substances to be removed can be used. However, according to the present invention, biomass particles from “energy plants” or fast-growing annual and perennial, non-woody C4 or C3 plants are naturally preferred, wherein C4 plants are characterised by a higher mass growth compared to the C3 plants native to Central Europe and therefore have a more efficient CO₂ utilisation and, as a result, a higher photosynthetic efficiency. Preferred particles according to the present invention are straw and straw-like materials. In agriculture, “straw” is defined as “dry stalks, stems and leaves of threshed cereals, legumes, and oil and fibre plants, and is also marketed as fuel, among other things. “Straw-like materials” are defined as grass species, whole plant cereals, miscanthus, Jerusalem artichokes, etc., i.e. the entire above-ground biomass growth of non-woody plants. Straw-like plant materials” is also understood to include energy crops such as reeds, shrub cuttings, leaves of trees and shrubs, bark, elephant grass, hay, and corncobs”.

DE 10 2009 046 127 A1 describes a method for producing wood fibre materials in which volatile organic compounds (“VOCs”), aliphatic and aromatic aldehydes, in particular hexanal and furfural, are reduced, wherein wood is treated with at least one compound to adjust a neutral to basic pH (such as NaOH) and at least one complexing agent (such as EDTA or DTPA). It is emphasised here that no bleaching, delignifying, oxidising or reducing chemicals are used for such a production and no pressing out of liquid formulation takes place before plasticising the wood or wood chips. However, the use of complexing agents such as EDTA and DTPA, as mentioned above, brings with it a serious wastewater and environmental problem. The present invention thus also brings decisive advantages over a mere chemical-thermal-mechanical pulping (CTMP) known per se, wherein wood chips are mixed with sodium sulphite and EDTA, more specifically both with regard to the environmental aspects and with regard to the effect according to the invention of the efficient depletion of fatty acids from the raw material.

U.S. Pat. No. 5,698,667 A discloses a pre-treatment of a lignocellulosic material by extraction with an organic solvent (e.g. acetone) to remove wood extractives, such as volatile organic compounds (VOCs) and pitch components of higher molecular weight without significantly adversely affecting integrity the of the lignocellulosic components of the material. However, no industrially usable depletion could be achieved with regard to the undesirable ingredients (the maximum depletion of pitch and VOCs was 54.4 and 65% (after two extractions for acetone in water (80/20) and 100% acetone), respectively, at most 78.2% for pure acetone, although the methodology used there cannot ensure that volatile components pass into the gas phase when the solvent is removed from the extract, and thus the depletions are to be set even lower when determined by the evaporation residue of the extract).

By contrast, in the method according to the invention, a large part of the fatty acids naturally occurring in the biomass is already removed before further processing (for example into cardboard or fibreboard) with the aid of an extractive pre-treatment of particles of non-woody biomass with organic solvents in an organic aqueous mixture of the solvent or solvents with water. In addition, this pre-treatment greatly reduces other extractives, such as aldehydes, pinenes, phenols and terpenes in the non-woody biomass. According to the invention, the hexanal content has proven to be an indicator for the auto-oxidation of fatty acids naturally occurring in the non-woody biomass, especially if it is determined after accelerated ageing of the particles (72 hours at 90° C.). According to the invention, this hexanal content is reduced by at least 70% relative to the potential of the starting raw material (as well as—in absolute contents), preferably to below 0.5 mg/kgDM. Thus, with the present invention, odour and taste interactions of products based on non-woody biomass with the environment relevant for the particular end use (for example, foodstuffs in the case of packaging board or room air in the case of fibreboard) can be greatly reduced. At the same time, the pre-treatment does not substantially change the composition of the particles, i.e. cellulose, hemicelluloses and lignin in the non-woody biomass are not extracted and/or degraded to any appreciable extent (in any case not reduced by more than 10%, preferably by no more than 6%, in particular by no more than 4%), this reduction preferably being determined as extracted solid mass, relative to the starting material, the biomass particles. Besides the reduction in the proportion of organoleptically relevant components in the particles, the present invention results in further important product and method advantages, in particular for paper, fibreboard and cardboard production:

Insoluble sticky residues based on the organic compounds contained in the non-woody biomass are removed from the process (or their formation in the production process is prevented) and thus cannot have a disruptive effect on the production process, so that there is no or reduced deposition on machine parts, rollers and clothing parts, etc.

This means that the present invention can also reduce disruptive effects on the surface of the paper/cardboard/fibreboard, which subsequently also significantly reduces problems during further processing of the paper/cardboard/fibreboard (e.g. printing). The significantly lower proportion of these components on the surface and also inside the paper/cardboard/fibreboard also results in improved product quality and an increase in mechanical strength.

Due to the above-mentioned improved product properties of products made from particles extracted according to the invention, it is also possible to open up new fields of application that can only be covered presently with paper/cardboard/fibreboard of which the fibre components originate from pulp and/or treated BCTMP (bleached chemi-thermo-mechanical pulp) (for example, high-quality packaging boards) or for particularly delicate applications that can only be handled presently with pulp.

In addition, the extractive pre-treatment according to the present invention also greatly reduces the COD loads of the wastewater from the process, allowing for greater production capacities while maintaining the same COD load in the wastewater.

The release of odour- and taste-active aldehydes in products based on non-woody biomass, such as cardboard or fibreboard, by auto-oxidation of fatty acids naturally occurring in the non-woody biomass can also be achieved according to the present invention completely without the addition of complexing agents. The addition of a complexing agent such as EDTA or DTPA in the production of the products based on non-woody biomass to reduce the odour and taste of these products is thus eliminated, whereby the EDTA/DTPA loading of the wastewater is eliminated, and thus the (ground) water-related environmental impact of the production of these products, as well as the EDTA/DTPA loading of the products themselves is avoided. Furthermore, besides fatty acids, other extractives are significantly reduced and thus eliminated from the process, which lowers the extractive loading of the process water in the production of the particles and thus results in lower demands on the wastewater purification/treatment. The reduced extractive loading of the process water also has the advantage that problems in the production process of the products produced from the particles treated according to the invention can be reduced and the quality of the products can variant be increased. This is therefore a particularly environmentally friendly embodiment of the present invention.

The specific method conditions (such as size, shape and dry substance content of the particles, choice of extractant, water content, temperature, treatment time, pH, extractant quantity (in relation to the used, non-woody biomass), pressure, number of extraction stages, variants of the contacting between extractant and solid, operating mode, etc.) required in practice for a certain non-woody biomass type or for certain non-woody biomass materials for an extraction of at least 70% of the fatty acids or for the establishment of a maximum absolute value of hexanal of below 2 mg/kg dry mass, preferably of below 1 mg/kg dry mass, in particular of below 0.5 mg/kg dry mass (in each case measured as hexanal content in wt. - % of the extracted particles after accelerated aging for 72 h at 90° C.). % of the extracted particles after accelerated aging for 72 h at 90° C. can be determined directly and without further inventive skill on the basis of the teaching disclosed herein, in particular taking into account the results presented in the example section, in particular in view of the (generally known) quantities of organic substances (such as fatty acids, pinenes, phenols, terpenes, etc.) of the non-woody biomass and the requirements for the final product (cardboard, paper, fibreboard, application in certain fields (foodstuffs, medicaments, animal feed, etc.).

In particular, the present invention can be relatively easily integrated into existing production facilities or operated with existing facilities.

One or more of the above objects can be achieved according to the invention by a method having the features of claim 1. embodiments with expedient developments of the Advantageous invention are indicated in the various dependent claims.

The choice of the liquid phase of the extract according to the invention (referred to here as the extractant) is also dependent on the relevant non-woody biomass type (and its natural content of extractives). However, the solvent or solvent mixture in the extractant must also be selected in such a way that no significant loss of cellulose, hemicelluloses and lignin occurs and the treatment time is nevertheless not excessively long. Mixtures of ethanol, acetone and water with 0-95 wt. % ethanol, preferably 50-90 wt. ethanol, and 0-99 wt. % acetone, preferably 30-90 wt. % acetone, as organic aqueous solvents in the extractant have proven to be particularly advantageous in this respect according to the invention. Other organic solvents that can be used instead of (or for certain purposes optionally together with) ethanol or acetone in the extractant with a view to working on an industrial scale are, for example, methanol, n-propanol and iso-propanol.

Preferred ratios of extractant to solid dry substance in the method according to the invention are 5:1-25:1 (w/w), preferably 8:1-17:1 (w/w).

The following considerations apply for the ratios and concentrations in the extractant stated herein: 100% extractant always means the total amount of extractant present after extraction, namely the extractant including the material extracted from the particles and the water contained in the non-woody biomass starting material (in the particles). However, since the amounts of non-woody biomass starting material are usually reported herein as “non-woody biomass dry matter” and the substances extracted from the non-woody biomass are usually less than 1% of the total mass of the extractant, the ratios before extraction correspond substantially (+/−1%) to the ratios after extraction (the water content provided, if any, in the non-woody biomass starting material, which is usually present in the case of economic utilisation, is therefore always already attributed to the extractant). Thus, using 100 wt. % acetone concentration of the extractant at 1:10 (solids: extractant) results in 1 kg non-woody biomass dry matter and 10 kg acetone. 70 wt. % acetone concentration of the extractant at 1:10 (solids: extractant) would then be, for example, 1 kg non-woody biomass dry matter, 7 kg acetone and 3 kg water. The extracted material would still be added, as mentioned, but experience shows that it moves at concentrations far below 1 wt. % in the extractant and is thus negligible. Due to the water content in the starting material, the organic aqueous mixture of the solvent (s) preferably contains at least 10% water, preferably at least 7.5% water, in particular at least 5% water, according to the invention, preferably in any case in a method with a single extraction step or (e.g. in a method with at least two extraction steps) in the first extraction step.

The extraction temperatures can also be determined on the basis of the other non-woody biomass and method parameters, in particular also taking into account the energy input that higher temperatures require. According to the invention, the treatment is preferably carried out at an extraction temperature of 20-150° C., preferably 40-120° C., in particular 50-110° C.

According to a preferred embodiment, the method according to the invention is operated at normal pressure; in certain cases, extraction under pressure may be advantageous (despite the additional energy expenditure of applying pressure). Therefore, according to a preferred embodiment, the treatment according to the invention is carried out at an absolute extraction pressure of 1-5 bar, preferably 1-1.49 bar.

With regard to the duration of the extraction method according to the invention, it is also possible to determine, on the basis of the other process parameters, what duration is required for the enrichment of fatty acids to be achieved. Preferably, the treatment according to the invention is carried out during an extraction time of 10 minutes-8 hours, preferably 30 minutes-7 hours, in particular 1-5 hours.

In principle, the present method is suitable for all non-woody biomass-based products in which organoleptic properties play a role. The method according to the invention is particularly suitable for products that are in use for a longer period of time, for food packaging or that are used indoors. Therefore, the method according to the invention is particularly suitable for the (large-scale) production of cardboard, paper, in particular special paper, fibreboard, chipboard, insulating materials, articles of daily use (for example (or in case of doubt) as defined in the Austrian Food Safety and Consumer Protection Act (LMSV, Federal Law Gazette I No. 13/2006, as amended on 1 Oct. 2020)), medical devices (for example (or in case of doubt) as defined in the Austrian Medical Devices Act (MPG, Federal Law Gazette No. 657/1996, as amended on 1 Oct. 2020)), food additives, pharmaceutical additives, such as excipients.

Particularly advantageous method parameters for the extraction treatment according to the present invention are selected from:
treatment with ethanol in a concentration of at least 65 wt. % at least 65° C. for a period of at least 3 h;
treatment with ethanol in a concentration of at least 65 wt. % at least 85° C. for a period of at least 30 min;
treatment with ethanol in a concentration of at least 70 wt. % at least 105° C. for a period of at least 30 min;
treatment with ethanol in a concentration of at least 45 wt. % at least 105° C. for a period of at least 5 h;
treatment with acetone in a concentration of at least 50 wt. % at least 40° C. for a period of at least 30 min; or
treatment with acetone in a concentration of at least 50 wt. % at least 20° C. for a period of at least 15 min.

In the context of the present invention, it has been found that batch as well as continuous and semi-continuous extractions are possible, and may even have a beneficial effect on the extraction result, especially if the partial residence time per extraction step is 1 hour or less.

When determining the method parameters, it is also important to select conditions that do not result in any significant loss of non-woody biomass substance (i.e. cellulose, hemicellulose and lignin content). Therefore, it can also be provided that, during the treatment according to the invention, the dry substance content of the particles used is reduced by less than 10%, preferably by less than 5%, in particular by less than 4%, this reduction preferably being determined as extracted solid mass, relative to the starting material, namely the particles based on non-woody biomass.

As already mentioned above, different non-woody plants vary in their contents of VOCs. Accordingly, the specific method parameters according to the invention must also be adjusted. However, since the disclosure of the invention herein enables this for all industrially relevant non-woody plant species, the particles used according to the invention can preferably be selected from the industrially relevant non-woody plant species, i.e., e.g. from cereal particles, legume particles, oil plant particles, fibre plant particles, grass particles, in particular miscanthus particles, Jerusalem artichoke particles, reed particles, shrub cuttings particles, leaf particles of trees and shrubs, bark particles, elephant grass particles, hay particles, corncob particles, or mixtures thereof.

According to a preferred embodiment, the particles are mixed with the extractant during treatment.

As already mentioned above, a preferred embodiment of the method according to the invention is that the particles are pressed out after the treatment with the extractant in order to remove the extractant. Preferably, after the (extraction) treatment with the extractant, the particles may be washed one or more times with an extractant, even more preferably with an organic aqueous solvent having a similar or the same concentration as that of the extractant. The extractant used in the extraction and/or washing may be removed from the particles by repeated washing with water and/or steam stripping and/or drying, with steam stripping and/or drying being particularly preferred. Both extractant and wash waters are preferably regenerated for reuse following the method according to the invention. As mentioned, the extractives, especially fatty acids and terpenes, can be separated from the extractant and used as by-products.

With the method according to the invention, it is possible to prepare particles in such a way that the content of fatty acids in the particles is reduced in such a way that the product to be manufactured from the raw materials from non-woody biomass does not have any organoleptically disadvantageous properties. Preferably, according to the invention, the extraction of the particles with the extractant reduces the content of fatty acids in the particles by at least 75%, preferably by at least 80%, in particular by at least 90%, measured as the hexanal content in wt. % of the particles in the starting material compared to the extracted particles, in each case after accelerated ageing for 72 hours at 90° C.

The particles thus obtained preferably have a content of fatty acids in the particles of less than 2 mg/kg dry matter, preferably of less than 1 mg/kg dry matter, in particular of less than 0.5 mg/kg dry matter, measured as hexanal content as a mass fraction of the extracted particles after accelerated ageing for 72 hours at 90° C.

In addition to reducing the hexanal content, the method according to the invention also makes it possible to increase the mechanical strength of the extracted particles, measured as the tensile index of sample sheets in Nm/g, by at least 10%, preferably by at least 15%, in particular by at least 25%, wherein the degree of grinding, measured in ° SR, changes by less than 10%.

It has been found according to the invention that, in addition to the extraction of fatty acids, the method according to the invention can also be used for the extraction of terpenes and pinenes (among other VOCs). Within the scope of a preferred embodiment, the fatty acids, terpenes, pinenes and/or optionally further extractives extracted into the extractant are fed to a further purification method and can then be made available as by-products of the production in extracted and optionally further purified form. This can be done in particular by mechanical separation technology after thermal separation of the organic solvent from the organic aqueous extractant, in order to separate the precipitated lipophilic extractants (such as fatty acids and resin acids), and to obtain an aqueous phase enriched with hydrophilic extractives (such as lignans), wherein the hydrophilic extractives can be further concentrated by subsequent treatment with thermal separation techniques (e.g. membrane separation methods and/or adsorption) (Lindemann et al., Selective recovery of polyphenols from MDF process waters by adsorption on a macroporous, crosslinked pyrrolidone-based resin (2019), Holzforschung Vol. 74 Issue 2). The extractive enrichments achieved can be further enhanced by prior membrane filtration of the extractant (Shi et al., Separation of vegetable oil compounds and solvent recovery using commercial organic solvent nanofiltration membranes (2019), Journal of Membrane Science 588; Weinwurm et al., Lignin Concentration by Nanofiltration and Precipitation in a Lignocellulose Biorefinery (2015), Chemical Engineering Transactions 45, pp. 901-906). The use of the lipophilic extractive fraction obtained by this method lends itself as an animal feed supplement (WO 2015/071534 A1, U.S. Pat. No. 10,092,610 B2), as the resin acids contained in the lipophilic extractive fraction inhibit the growth of harmful bacteria in the animal digestive tract and thus prevent digestive disorders, which has already been shown by various studies, especially for poultry (Kettunen et al., Natural resin acid-enriched composition as a modulator of intestinal microbiota and performance enhancer in broiler chicken (2015), Journal of Applied Animal Nutrition Vol. 3; Kettunen et al., Dietary resin acid composition as a performance enhancer for broiler chickens (2017), Journal of Applied Animal Nutrition Vol. 5, pp. 349-355; Vienola et al., Tall oil fatty acid inclusion in the diet improves performance and increases ileal density of lactobacilli in broiler chickens (2018) British Poultry Science Vol. 59 No. 3).

According to a preferred embodiment, no complexing agents, in particular complexing agents selected from polyvalent and polyfunctional carboxylic acids, aminomethylcarboxylic acids, aminomethylphosphonic acids and compounds thereof, EDTA, DTPA, EGTA, EDDS and salts thereof, polyphenols, tannins, amino acids, peptides, proteins, polycarboxylates, phosphates, polyphosphates, phosphonic acids, polyphosphonates, phosphated, phosphonylated, sulphated and sulphonated polymers, are added to the particles in the course of the extraction process, in particular in the course of the entire production method for the products produced from the particles. In this embodiment, the method according to the invention represents an extremely advantageous and practical variant for ecological reasons alone.

According to a further aspect, the present invention relates to a method according to the invention for producing products based on wood as raw material, in which—instead of the non-woody biomass which contains cellulose, hemicelluloses and lignin and is in the form of particles—wood in the form of wood particles is used as starting material, and wherein the extractives extracted using the extractant, i.e. preferably fatty acids, terpenes, pinenes and/or optionally further extractives, are fed to a further purification process, namely by mechanical separation technique after thermal separation of the organic solvent from the organic aqueous extractant, wherein lipophilic extractants, in particular fatty acids and resin acids, are precipitated and separated, and an aqueous phase enriched with hydrophilic extractants, in particular lignans, is obtained, wherein preferably the hydrophilic extractants are further concentrated by subsequent treatment with a thermal separation technique, in particular by means of a membrane separation method and/or adsorption. Preferably, a preceding membrane filtration of the extractant takes place during the extractive enrichment. According to a preferred embodiment of this aspect of the present invention, the wood particles are selected from coniferous wood particles, preferably spruce wood particles, fir wood particles, pine wood particles, or larch wood particles; hardwood particles, in particular beech wood particles, poplar wood particles, birch wood particles, or eucalyptus wood particles; or mixtures thereof. The lipophilic extractive fraction obtained according to the invention is preferably used as an animal feed supplement.

Further features of the invention can be found in the claims, the figures and the figure description. The features and combinations of features mentioned above in the description, as well as the features and combinations of features mentioned below in the figure description and/or shown alone in the figures, can be used not only in the combination indicated in each case, but also in other combinations without departing from the scope of the invention. Thus, embodiments which are not explicitly shown and explained in the figures, but which arise from the explained embodiments and can be produced by separate combinations of features are also to be regarded as encompassed and disclosed by the invention. Embodiments and combinations of features which thus do not have all the features of an originally formulated independent claim are also to be regarded as disclosed. Moreover, embodiments and combinations of features which go beyond or deviate from the combinations of features set out in the back-references of the claims are to be regarded as disclosed, in particular by the embodiments set out above. In particular, the present invention will be explained in greater detail with reference to the following examples and figures, without of course being limited thereto. In the figures:

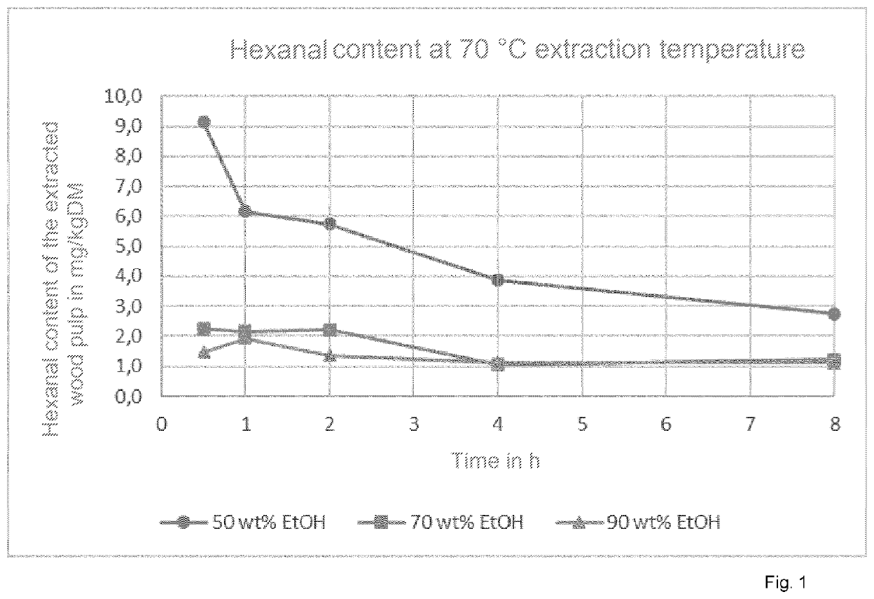

FIG. 1 shows the hexanal content at 70° C. extraction temperature. The x-axis shows the extraction time in h; the y-axis the hexanal content of the extracted wood pulp in mg/kgDM;

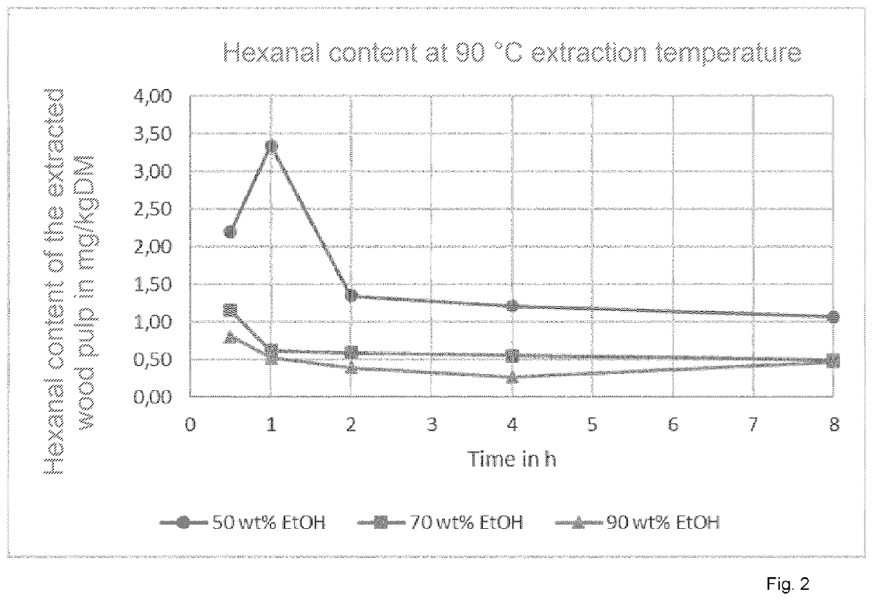

FIG. 2 shows the hexanal content at 90° C. extraction temperature. The x-axis shows the extraction time in h; the y-axis the hexanal content of the extracted wood pulp in mg/kgDM;

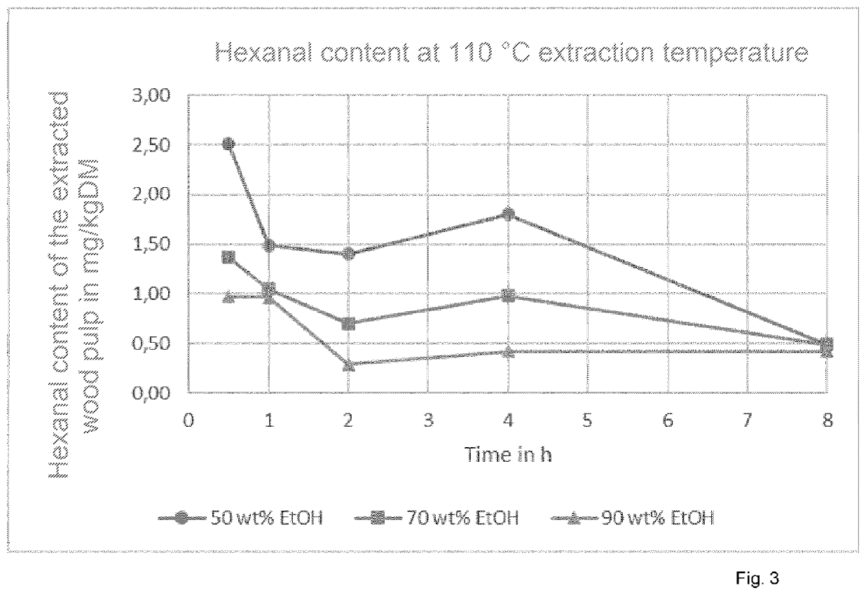

FIG. 3 shows the hexanal content at 110° C. extraction temperature. The x-axis shows the extraction time in h; the y-axis the hexanal content of the extracted wood pulp in mg/kgDM;

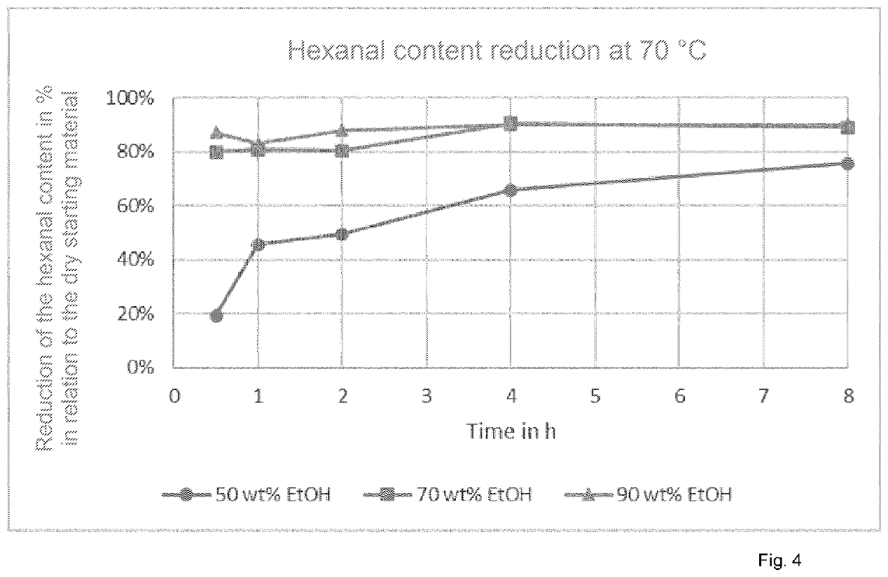

FIG. 4 shows the hexanal content reduction at 70° C. extraction temperature. The x-axis shows the extraction time in h; the y-axis the reduction of the hexanal content in & in relation to dry starting material;

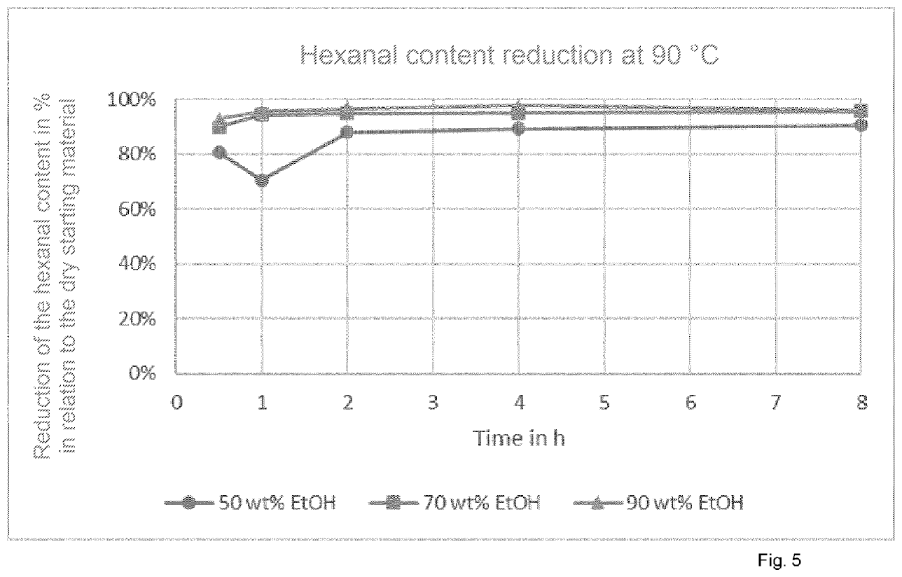

FIG. 5 shows the hexanal content reduction at 90° C. extraction temperature. The x-axis shows the extraction time in h; the y-axis the reduction of the hexanal content in & in relation to dry starting material;

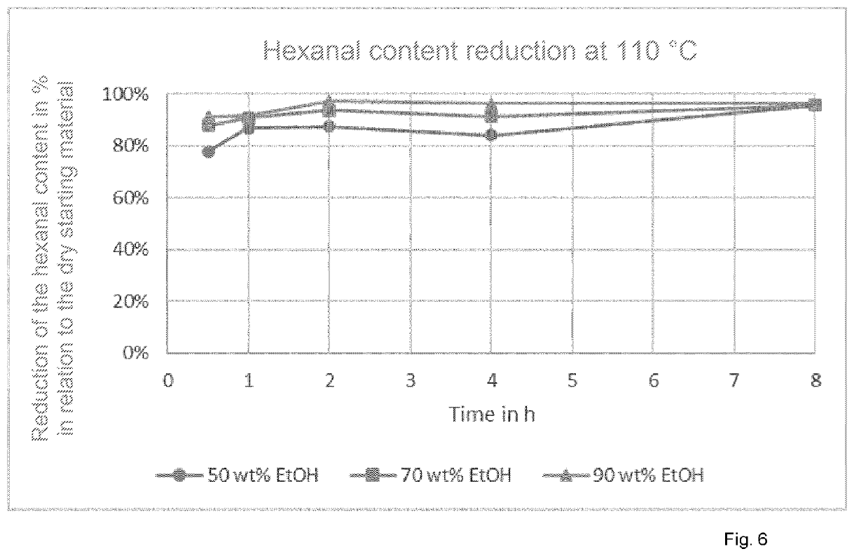

FIG. 6 shows the hexanal content reduction at 110° C. extraction temperature. The x-axis shows the extraction time in h; the y-axis the reduction of the hexanal content in % in relation to dry starting material.

### EXAMPLES

The objective of the developed method in this patent is a significant improvement of the organoleptic properties of particles from non-woody biomass as well as aged particles from this biomass, which are produced according to this method. The undesirable odour of the non-woody biomass particles and the taste of the foodstuffs that come into contact with them—especially after ageing (up to 6 months)—is mainly caused by aldehydes (very particularly hexanal), which are formed by autocatalytic oxidation of fatty acids (especially linoleic acid) naturally occurring in the non-woody biomass. As mentioned above, this autocatalytic oxidation is currently prevented or greatly slowed down industrially—in the processing of wood biomass—by the complexation of the metal ions present in the wood particles, which act as a catalyst, by means of the addition of complexing agents such as ethylenediaminetetraacetic acid (EDTA). The method according to the present invention achieves a significant improvement of the organoleptic properties of the particles from non-woody biomass also without the addition of complexing agents, but by removing potential aldehyde sources, first and foremost fatty acids.

Since fatty acids as a source of aldehydes, and subsequently as a source of organoleptic impairments of the particles from non-woody biomass, can only be satisfactorily quantified with great effort when using measurement technology, and because the application of the technology according to the invention to wood particles has already been carried out (and is shown by a person skilled in the art to be directly applicable to particles of non-woody biomass), the application of the technology according to the invention to wood particles was shown in the following examples for the evaluation of the extraction success of the tests according to the present invention, and in particular the hexanal content of the wood particles after ageing was also used. At this point, it should be noted that 0.5 mg/kgDM hexanal (in relation to dry wood) marks the empirically determined value below which organoleptic impairments are, according to experience, no longer sensorially perceptible. Of course, this also applies to particles from non-woody biomass. For hexanal contents of wood particles and particles from non-woody biomass>0.5 mg/kgDM, the following applies: The higher the hexanal content, the higher the organoleptic impairment of the wood particles or the particles from non-woody biomass.

The hexanal content can be determined using headspace gas chromatography (HS-GC) by filling about 0.2 g of air-dried wood particles (90-95 wt. % DSC) into a headspace vial. In these vials, the wood particles must then be sealed and aged at room temperature (about 20° C.) for six months in order to oxidise the fatty acids to hexanal. Since this takes a long time and thus does not allow a timely assessment of the extraction success, accelerated ageing according to DIN ISO 5630-2 was carried out for the present tests (unless explicitly stated otherwise). The wood particles were sealed in HS-GC vials, aged for 72 hours at 90° C. and the hexanal content was subsequently determined by HS-GC. Although this standard for accelerated ageing has been withdrawn, the extraction tests carried out show in Table 1 that the accelerated ageing method yields comparable values and the hexanal values are even higher on average with accelerated ageing and thus offer even more certainty with regard to the extraction success. As mentioned, the tests and test results given in the present example section are substantially the same for the wood particles due to the analogy of the starting materials (wood particles or particles from non-woody biomass) (depending on the comparability of the particles with regard to the organoleptic compounds extracted according to the invention; however, this also applies to specific compounds from particles from non-woody biomass, such as terpenes and pinenes, which are analogous to the hexanal analysed in the following examples (e.g. from linoleic acid)).

TABLE 1

| | Hexanal content aged | Hexanal content |
|---|---|---|
| | under acceleration for | naturally aged for |
| Analysed wood | 72 hours at 90° C. | 6 months at 20° C. |
| particles | in mg/kgDM | in mg/kgDM |
| Starting material | 11.37 | 10.62 |
| Extracted wood | 2.14 | 1.41 |
| particles 1 | | |
| Extracted wood | 2.17 | 1.52 |
| particles 2 | | |
| Extracted wood | 2.80 | 1.74 |
| particles 3 | | |
| Extracted wood | 3.32 | 2.57 |
| particles 4 | | |
| Extracted wood | 3.64 | 2.75 |
| particles 5 | | |
| Extracted wood | 1.34 | 2.72 |
| particles 6 | | |
| Extracted wood | 2.35 | 1.69 |
| particles 7 | | |
| Extracted wood | 2.86 | 2.83 |
| particles 8 | | |

The hexanal content was used for the extraction success of all tests according to the present invention, as experience has shown that this is the main factor influencing the organoleptic impairment of wood particles but also of particles from non-woody biomass. The extractant content by means of Soxhlet extraction according to TAPPI standard T204 is too inaccurate for this, as Table 2 shows. At this juncture it should be noted that, for the determination of the extractant content of the wood particles of all tests in this patent, not the TAPPI standard T204, but instead the NREL method NREL/TP-510-42619, which is very similar to T204, was used and wood pulp or 2 mm wood particles were used instead of wood flour as starting material.

TABLE 2

| | | | | | Determined |
|---|---|---|---|---|---|
| | | | | | extractant |
| | | | | | content of the |
| | Hexanal content of | | Hexanal content of the | | extracted wood |
| | the starting material | | extracted wood particles | | particles in |
| | in mg/kgDM | | in mg/kgDM | | wt. % in rel. to |
| | Mean | | Mean | | the starting |
| Solvent | value | STDEV | value | STDEV | material |
| Ethanol | 14.07 | 1.13 | <0.20 | — | 3.4 |
| Ethanol | 14.07 | 1.13 | <0.20 | — | 3.0 |
| Acetone | 14.07 | 1.13 | 0.32 | 0.2 | 3.0 |
| Acetone | 14.07 | 1.13 | 0.27 | 0.1 | 2.6 |

As can be seen in Table 2, the Soxhlet extractions with ethanol differ significantly from one with acetone in hexanal content, but not significantly in extractant content. This means that, for example, two differently extracted wood particles can have different organoleptic properties despite not having significantly different extractant content. The hexanal content of the wood particles after ageing is thus a much stronger and more accurate indicator of organoleptic impairment than the extractant content, and was therefore used to determine extraction success according to the present invention. In addition, the hexanal content of the starting material and the resulting reduction in hexanal content was given for all tests, as the starting materials are snapshots and the hexanal content can therefore sometimes vary greatly.

Nevertheless, the extracted extractant mass (determined as evaporation residue of the extract) is an important indicator for the solid mass loss of the extractions, as it includes—except for a few very volatile compounds—almost the entire solid mass extracted. Thus, the evaporation residue of the extract together with the hexanal content of the extracted wood particles is an important measure for assessing the selectivity of the extractions.

### Test: Comparison of Solvents on the Basis of Soxhlet Extractions

For solvent pre-selection, wood pulp samples were extracted using three different solvents. In each case, 3 g of air-dry wood pulp was extracted for 24 hours using the Soxhlet method according to NREL procedure NREL/TP-510-42619. The results are shown in Table 3.

TABLE 3

| | | | | Determined |
|---|---|---|---|---|
| | | | | extractant |
| | | | | content of the |
| | | Hexanal | Hexanal | extracted wood |
| | | content of | content of | particles in |
| | | the starting | the extracted | et. % in rel. |
| Solvent 1 | Solvent 2 | material | wood pulp | to the starting |
| (24 h) | (24 h) | in mg/kgDM | in mg/kgDM | material |
| Cyclohexane | — | 11.32 | 2.36 | 1.0 |
| Ethanol | Cyclohexane | 11.32 | <0.20 | 3.4 |
| Ethanol | — | 11.32 | <0.20 | 3.1 |
| Ethanol | — | 14.07 | <0.20 | 3.0 |
| Acetone | — | 14.07 | 0.32 | 3.0 |

Table 3 shows that even at higher hexanal contents of the starting material, ethanol extracts best, followed by acetone. Cyclohexane extracts by far the worst, which means that completely non-polar solvents are unsuitable for the extraction of fatty acids. According to Reichardt and Welton (Reichardt and Welton, Solvents and Solvent Effects in Organic Chemistry⁴ (2011), Weinheim: Wiley-VCH Verlag GmbH & Co. KGaA, pp 550-552), the empirically determined polarity of cyclohexane is 0 (very nonpolar) compared to 0.355 of acetone and 0.654 of ethanol. Nevertheless, extraction with cyclohexane also reduced the hexanal content by 79%.

### Test 1: Extraction of Dry Wood Pulp

Using the extraction of air-dry wood pulp (consisting of about 95% spruce and 5% pine) with ethanol (EtOH), the influence of the parameters of solvent concentration, temperature and extraction time was investigated. For this purpose, about 2 g of air-dry wood pulp was extracted in an ethanol-water mixture with a solids: extractant ratio of 1:10 w/w and ethanol concentrations of 50, 70 and 90 wt. % at temperatures of 70, 90 and 110° C. for 0.5, 1, 2, 4 and 8 hours, respectively, in small autoclaves. After extraction, the wood pulp was pressed out, washed with ethanol, pressed out again and washed again with demineralised water before being dried, aged and analysed. FIGS. 1 to 3 show the hexanal contents achieved by extraction at the different extraction temperatures and solvent concentrations over the extraction time.

FIGS. 1 to 3 show that the extraction success at 70 or 90 wt. % ethanol is significantly compared improved to one at 50 wt. % —especially at lower temperatures. Ethanol concentrations of 70 or 90 wt. % ethanol lower the hexanal content to a comparable level. In terms of extraction temperatures, it appears that 90 and 110° C. lower the hexanal content about the same, while at 70° C. it is not reduced as much. At 90 wt. % ethanol, the hexanal content can even be reduced below the 0.5 mg/kgDM mark from 90° C. onwards, which means that the groundwood pulp extracted under these conditions no longer shows any organoleptic impairments, according to experience. Based on the different extraction times, it can be seen that the hexanal content decreases the most at the beginning of the extraction, and especially in the first 4 hours. This can also be seen in FIGS. 4 to 6. These figures reflect the extraction results shown in FIGS. 1 to 3, as the same batch of starting material was used for all tests in this series of tests. It is clearly visible that in the worst case (0.5 hours with 50 wt. % ethanol at 70 wt. %) the hexanal content could only be reduced by about 20%, whereas, at 90 wt. % ethanol, from 90° C. it was reduced by over 95%.

Table 4 shows that, despite the high hexanal content reductions achieved in this series of tests, the extracted solid matter amounts to max. 7 wt. % (in relation to the starting material)—but mostly significantly less. With a determined extract content of the starting material of about 3 wt. %, this means that neither hemicelluloses nor lignin is extracted to any appreciable extent.

TABLE 4
Extracted solid matter in wt. % (in rel. to the starting material)

| Extraction period | | | | | |
|---|---|---|---|---|---|
| in hours | 0.5 | 1.0 | 2.0 | 4.0 | 8.0 |

| | | | | | | |
|---|---|---|---|---|---|---|
| 70° C. | 50 wt. % EtOH | 4.3 | 4.6 | 4.4 | 4.0 | 3.6 |
| | 70 wt. % EtOH | 4.9 | 5.1 | 4.8 | 5.6 | 4.2 |
| | 90 wt. % EtOH | 4.5 | 5.5 | 5.7 | 5.3 | 6.1 |
| 90° C. | 50 wt. % EtOH | 3.7 | 3.5 | 4.0 | 4.7 | 5.1 |
| | 70 wt. % EtOH | 4.0 | 4.4 | 4.8 | 4.8 | 5.4 |
| | 90 wt. % EtOH | 5.5 | 5.6 | 5.9 | 5.8 | 5.6 |
| 110° C. | 50 wt. % EtOH | 4.7 | 4.1 | 5.3 | 6.2 | 6.3 |
| | 70 wt. % EtOH | 5.2 | 6.6 | 5.7 | 5.8 | 7.2 |
| | 90 wt. % EtOH | 5.8 | 5.7 | 6.8 | 6.5 | 6.4 |

Test 2: Extraction of Moist Groundwood Pulp with Ethanol Under Different Conditions

The extraction of moist groundwood pulp represents real conditions much better than the extraction of dry groundwood pulp, such as test 1, especially in cardboard production. In addition, considerably more sample mass was taken for these tests (factor 225) than for test 1 in order to obtain a more meaningful result. About 450 gDM of mechanically dehydrated wood pulp (about 25 wt. % DSC; about 95% spruce and 5% pine) was extracted in an ethanol-water mixture with a solids: solvent ratio of 1:10 w/w and ethanol concentrations of 60 wt. % at temperatures of 70 and 90° C. for 2 and 4 hours in an autoclave. After extraction, the wood pulp was pressed out, washed with ethanol, pressed out again and washed again with demineralised water before being dried, aged and analysed. Table 5 shows the results of these extractions.

TABLE 5

| | | | Hexanal content | | Hexanal content of | | |
|---|---|---|---|---|---|---|---|
| | Extraction | | of the starting | | the extracted wood | | Reduction of the |
| EtOH | conditions | | material in mg/kgDM | | material in mg/kgDM | | hexanal content |
| concentration | Temperature | Duration | Mean | | Mean | | in rel. to the |
| in wt. % | in ° C. | in hours | value | STDEV | value | STDEV | starting material |
| 60 | 70 | 2 | 11.37 | 0.18 | 3.06 | 1.18 | 73% |
| 60 | 70 | 4 | 11.37 | 0.18 | 2.15 | 1.00 | 81% |
| 60 | 90 | 2 | 11.37 | 0.18 | 2.60 | 0.88 | 77% |
| 60 | 90 | 4 | 11.37 | 0.18 | 2.49 | 1.50 | 78% |

The tests show that—compared to the extraction of lower and especially air-dry wood pulp mass—the tests with mechanically dewatered wood pulp and more sample mass show higher hexanal contents in the extracted wood pulp. Nevertheless, a reduction of more than 73% in the hexanal content was achieved in each setting.

### Test 3: Extraction of Moist Wood Pulp Using Three Different Organic Solvents

Test 3 was conducted to test three different technically relevant solvents under real extraction conditions. About 450 gDM of mechanically dewatered wood pulp (about 25 wt. % DSC; about 95% spruce and 5% pine) was extracted in a solvent-water mixture with a solids: extractant ratio of 1:10 w/w and a solvent concentration of 70 wt. % at a temperature of 70° C. for 4 hours in an autoclave. After extraction, the wood pulp was pressed out, washed with extractant, pressed out again and washed again with demineralised water before being dried, aged and analysed. Table 6 shows the results of these extractions.

TABLE 6

| | Hexanal content | | Hexanal content of | | | Evaporation residue of the extract | | Reduction of |
|---|---|---|---|---|---|---|---|---|
| | of the starting | | the extracted wood | | Reduction of | in wt. % in rel. to the starting | | the abietic |
| | material in mg/kgDM | | material in mg/kgDM | | the hexanal | material dry matter | | acid content |
| | Mean | | Mean | | content in | Starting | Extracted | in rel. to the |
| Solvent | value | STDEV | value | STDEV | rel. to the | material | wood pulp | starting material |
| Ethanol 96 | 14.07 | 1.13 | 4.92 | 0.40 | 65% | 3.6 | 2.4 | 48% |
| vol. % | | | | | | | | |
| undenatured | | | | | | | | |
| Ethanol 96 | 14.07 | 1.13 | 2.77 | 0.04 | 80% | 3.6 | 2.4 | 48% |
| vol. % | | | | | | | | |
| incompletely | | | | | | | | |
| denatured | | | | | | | | |
| Acetone | 14.07 | 1.13 | 3.43 | 0.04 | 6% | 3.6 | 2.2 | 55% |

As can be seen in Table 6, acetone extracts the unsaturated fatty acids responsible for hexanal formation significantly better than undenatured ethanol. However, the best extraction results were obtained with ethanol incompletely denatured with butanone. The hexanal content of 2.77 mg/kgDM achieved with 70 wt. 8, 70° C. and 4 hours extraction time is still clearly above the 0.5 mg/kgDM limit, but corresponds to a reduction of 80%. In all extractions, the evaporation residue of the extract is only between 2.2 and 2.4 wt. % in relation to the starting material dry substance, which means with a determined extract material content of 3.6 wt. % that the main wood components cellulose, hemicelluloses and lignin were de facto not attacked and the extractions were thus very selective. The abietic acid content of the extractions in this trial was reduced by 41-55%, in relation to the starting material. Since abietic acid was chosen here as the lead substance for the content of resin acids, a reduction of the content by about 50% is an indication of the significant reduction of resin by the method of this patent.

Test 4: Extraction of Moist Wood Pulp with Acetone at Different Solids: Extractant Ratios

The influence of different solids: extractant ratios was investigated in this test. About 200-450 gDM (depending on the solids: extractant ratio) of mechanically dehydrated wood pulp (about 25 wt. % DSC; about 95% spruce and 5% pine) was extracted in an acetone-water mixture consisting of 70 wt. % acetone and 30 wt. % demineralised water with solids: extractant ratios of 1:10, 1:15 and 1:25 w/w at a temperature of 50° C. for 1, 2 and 4 hours in an autoclave. After extraction, the wood pulp was pressed out, washed with extractant, pressed out again and washed again with demineralised water before being dried, aged and analysed. The results of these extractions are listed in Table 7.

TABLE 7

| | | | | | | | Evaporation | |
|---|---|---|---|---|---|---|---|---|
| | | | | | | | residue of | |
| | | | | | | | the extract | Reduction of the |
| | | Hexanal content of | | Hexanal content of | | | in wt. % in | abietic acid |
| | | starting material | | the extracted wood | | Reduction of the | rel. to the | content in |
| Solids/ | Extraction | in mg/kgDM | | material in mg/kgDM | | hexanal content | starting | rel. to the |
| extractant | time in | Mean | | Mean | | in rel. to the | material | starting |
| ratio w/w | hours | value | STDEV | value | STDEV | starting material | dry matter | material |
| 1:10 | 4 | 14.07 | 1.13 | 5.83 | 0.18 | 59% | 2.0 | 31% |
| 1:15 | 4 | 14.07 | 1.13 | 2.76 | 0.15 | 80% | 2.5 | 54% |
| 1:15 | 2 | 7.24 | 0.03 | 1.19 | 0.72 | 84% | — | 38% |
| 1:25 | 2 | 7.24 | 0.03 | 0.94 | 0.23 | 87% | — | 52% |
| 1:10 | 1 | 2.44 | 0.11 | 0.40 | 0.04 | 84% | 2.2 | — |
| 1:10 | 2 | 2.44 | 0.11 | 0.40 | 0.05 | 84% | 1.5 | — |
| 1:15 | 2 | 2.44 | 0.11 | 0.39 | 0.01 | 84% | 2.5 | — |
| 1:25 | 2 | 2.44 | 0.11 | 0.33 | 0.01 | 86% | 2.8 | — |

As Table 7 shows, the hexanal content is reduced by more than 80% in all extractions (except for the solids: extractant ratio of 1:10 (w/w) at a starting material hexanal content of 14.07 mg/kgDM). For extractant:solids ratios above 10:1 (w/w), the reduction of the hexanal content under the same extraction conditions is comparably high and always far above 70% despite different starting material hexanal contents. The evaporation residue of the extract is less than 3%, which is proof of the quantitative retention of the lignocellulose components in this process, given the determined extract content of the starting material of 3.4-3.7 wt. %. This test also demonstrated that the method of this patent can significantly reduce resin by reducing the abietic acid content by 31-54%, in relation to the starting material.

Test 5: Multi-Stage Extraction of Moist Wood Pulp with Acetone

In this test, multi-stage extractions were carried out, using fresh unloaded extractant for each stage (=one hour each). The wood pulp (about 400-450 gDM; about 25 wt. % DSC) was pressed out after each extraction stage (to about 30 wt. % DSC) and mixed with acetone and fully demineralised water (both preheated to 50° C. extraction temperature) so that the solids: extractant ratio was 1:10 and the acetone concentration in the extractant was 70 wt. %. The extractions were carried out in an autoclave. After extraction, the wood pulp was pressed out, washed with extractant, pressed out again and washed again with demineralised water before being dried, aged and analysed. The results of these extractions are listed in Table 8.

TABLE 8

| | | | | | | | Evaporation | |
|---|---|---|---|---|---|---|---|---|
| | | | | | | | residue of | |
| | | | | | | | the extract | Reduction of the |
| | | Hexanal content | | Hexanal content of | | | in wt. % in | abietic acid |
| | Extraction | of the starting | | the extruded wood | | Reduction of the | rel. to the | content in |
| | stage number | material in mg/kgDM | | material in mg/kgDM | | hexanal content | starting | rel. to the |
| | of extraction | Mean | | Mean | | in rel. to the | material | starting |
| Wood type | time in hours | value | STDEV | value | STDEV | starting material | dry matter | material |
| 95% spruce | 1 | 2.44 | 0.11 | 0.40 | 0.04 | 84% | 2.2 | 62% |
| 5% pine | 2 | 2.44 | 0.11 | <0.20 | — | >92% | 2.7 | 78% |
| | 3 | 2.44 | 0.11 | <0.20 | — | >92% | 2.9 | 90% |
| | 4 | 2.44 | 0.11 | <0.20 | — | >92% | 3.0 | 99% |
| 95% spruce | 1 | 9.43 | 0.66 | 0.98 | 0.19 | 90% | 2.6 | 55% |
| 5% pine | 2 | 9.43 | 0.66 | 0.54 | 0.20 | 94% | 3.2 | 80% |
| | 3 | 9.43 | 0.66 | 0.47 | 0.06 | 95% | 3.3 | 95% |
| | 4 | 9.43 | 0.66 | 0.50 | 0.05 | 95% | 3.4 | 100% |
| 95% spruce | 1 | 6.73 | 1.71 | 0.30 | 0.07 | 96% | 1.9 | — |
| 5% fir | 2 | 6.73 | 1.71 | 0.23 | 0.04 | 97% | 2.2 | — |
| | 3 | 6.73 | 1.71 | 0.24 | 0.05 | 96% | 2.3 | — |

As Table 8 shows, the hexanal content is already reduced by more than 80% after the first stage in all extractions, but is still significantly above 0.50 mg/kgDM, especially in the case of a starting material with higher hexanal contents. After stage three, however, the hexanal content is below 0.50 mg/kgDM in all extracted wood pulps of this test, in some cases even below the determination limit of 0.20 mg/kgDM. The evaporation residue of the extract is less than 3.5% here, which is proof of the quantitative retention of the lignocellulose constituents s in this method, given the determined extract content of the starting material of 2.5-3.7 wt. %. This test also demonstrated, by reducing the abietic acid content by 55-100% in relation to the starting material, that the method of this patent can significantly reduce resin, especially as the number of extraction stages increases.

Test 6: Multi-Stage Extraction of Moist Wood Particles of Different Particle Sizes with Acetone

The influence of particle size was investigated in this test with different extraction parameters. About 650 gDM wood chips (about 20 mm; about 55 wt. % DSC; spruce), about 450 gDM shredded wood chips (2 mm mesh size of the granulator screen; about 60 wt. % DSC; spruce) and about 400 gDM of mechanically dewatered wood pulp (about 25 wt. % DSC; about 95% spruce and 5% fir) were extracted in two stages (one hour each) at 50° C. and in two stages (30 minutes each) at 21° C. in an autoclave. The multi-stage extractions were carried out in the same way as in test 5 by pressing off the wood particles after each extraction stage and mixing with fresh, unloaded extractant. The extraction parameters were 50° C., extraction times of 1 hour per extraction stage and acetone concentrations of 70 wt. % in the extractant (extraction parameter 1) as well as 21° C., extraction times of 30 minutes per extraction stage and pure acetone as added extractant resulting in acetone concentrations of 70-99 wt. % depending on extraction stage and particle size (extraction parameter 2). The solids: extractant ratios were chosen so that the wood particles were just covered with extractant (1:6 for wood chips and ground wood chips and 1:10 for ground wood). After extraction, the wood particles were pressed out (and washed with extractant for extraction parameter 1) and pressed out again before being dried, aged and analysed. The results of these extractions are listed in Table 9.

TABLE 9

| | | | Hexanal content | | Hexanal content of | | | Evaporation residue | Reduction of the extract |
|---|---|---|---|---|---|---|---|---|---|
| | | | of the starting | | the extracted wood | | Reduction of the | of the extract in wt. | evaporation residue in |
| Wood | | Extraction | material in mg/kgDM | | material in mg/kgDM | | hexanal content | % in rel. to the | rel. to the extract |
| particle | Extraction | time in | Mean | | Mean | | in rel. to the | starting material | evaporation residue of |
| form | parameter | hours | value | STDEV | value | STDEV | starting material | dry matter | the starting material |
| wood | 1 | 1.0 | 21.36 | 3.55 | — | — | — | 1.0 | 51% |
| chips | | 2.0 | 21.36 | 3.55 | 17.10 | 2.32 | 20% | 1.5 | 73% |
| | 2 | 0.5 | 21.36 | 3.55 | — | — | — | 0.7 | 35% |
| | | 1.0 | 21.36 | 3.55 | 15.55 | 2.36 | 27% | 0.9 | 46% |
| shredded | 1 | 1.0 | 21.36 | 3.55 | 1.52 | 0.26 | 93% | 1.7 | 84% |
| wood | | 2.0 | 21.36 | 3.55 | 1.07 | 0.18 | 95% | 2.1 | 100% |
| chips | 2 | 0.5 | 21.36 | 3.55 | 5.16 | 0.78 | 76% | 1.3 | 65% |
| | | 1.0 | 21.36 | 3.55 | 1.70 | 0.47 | 92% | 1.6 | 79% |
| wood | 1 | 1.0 | 6.73 | 1.71 | 0.30 | 0.07 | 96% | 1.9 | 75% |
| pulp | | 2.0 | 6.73 | 1.71 | 0.23 | 0.04 | 97% | 2.2 | 88% |
| | 2 | 0.5 | 6.73 | 1.71 | 2.18 | 1.11 | 68% | 1.8 | 70% |
| | | 1.0 | 6.73 | 1.71 | 0.41 | 0.07 | 94% | 2.1 | 83% |

As Table 9 shows, the hexanal content of wood chips can only be reduced by about 20-30% with the method according to the invention. If the wood chips are ground to a particle size of 2 mm, as also specified by the NREL method NREL/TP-510-42620, on the other hand, the hexanal content can be reduced to about 1 mg/kgDM using the method according to the invention, which corresponds to a reduction of about 95% for the initial hexanal content of 21.36 mg/kgDM. For even smaller particle sizes, such as wood pulp, the reduction of the hexanal content is even higher at about 978. The two extraction parameters provide comparable hexanal contents for larger particle sizes, whereas for smaller particle sizes, especially groundwood pulp, extraction parameter 1 (higher temperature and longer extraction time) provides significantly better results. In the reduction of the extract evaporation residue related to the extract evaporation residue of the starting material oxhlet extraction, the extraction parameters provide better results for all particle sizes. Table 9 also shows that the reduction of the extract/vapour residue in relation to the extract/vapour residue of the starting material oxhlet extraction cannot be used as an indicator for the extraction success of the intended process, since, for example, in the case of wood chips, even with a high reduction of 73%, the hexanal content was only reduced by about 20, whereas in the case of groundwood pulp the hexanal content was reduced by about 96% with a reduction of the extract evaporation residue by 75% relative to the extract evaporation residue of the starting material oxhlet extraction.

### Test 7: Modification of the Mechanical Properties by Extractive Treatment of Wood Pulp According to the Present Invention

The purpose of this test is to investigate the effects of extractive treatment on the mechanical properties of the extracted wood particles. For this purpose, about 300-450 gDM (depending on the solids: extractant ratio) of mechanically dehydrated wood pulp (about 25 wt. % DSC) were extracted in a solvent-water mixture with solids: extractant ratios of 1:10 and 1:15 w/w and a solvent concentration of 60 and 70 wt. % at temperatures of 50° C., 70° C. and 90° C. The solvents used were ethanol 96 vol. % undenatured (EtOH pur), ethanol 96 vol. % incompletely denatured with butanone (EtOH denat.) and acetone. After extraction, the wood pulp was pressed out, washed with extractant, pressed out again and washed once more with demineralised water before sample sheets were formed, on the basis of which the mechanical properties were examined. The mass loss results from the evaporation residue of the extract and is related to the dry matter of the starting material. Table 10 lists the results.

TABLE 10

| | | | | | Average increase in | | | |
|---|---|---|---|---|---|---|---|---|
| | | | | | mechanical properties | | | |
| | | | | | Stiffness | Tensile | Degree of | Average |
| Extraction conditions | | | | | index | index | grinding | mass loss |
| | | Extract. | | | meas. in | meas. in | meas. in | by the |
| Solvent | Conc. | method | Temp. | Time | Nm⁷/kg³ | Nm/g | ° SR | extraction |
| EtOH pur | 60 wt. % | 1:10 | 70° C. | 2 h | 3% | 25% | 3% | 2% |
| | | | 90° C. | 4 h | | | | |
| EtOH pur | 70 wt. % | 1:10 | 70° C. | 2 h | 3% | 41% | 0% | 2% |
| | | | | 4 h | | | | |
| | | | | 8 h | | | | |
| EtOH pur | 70 wt. % | 1:10 | 50° C | 4 h | 4% | 27% | 6% | 2% |
| EtOH | | 1:15 | 70° C | | | | | |
| denat. | | | | | | | | |
| Acetone | | | 90° C | | | | | |
| Acetone | 70 wt. % | 1:10 | 50° C. | 4 × | 4% | 20% | 2% | 3% |
| | | | | 1 h | | | | |
| Acetone | 70 wt. % | 1:10 | 50° C. | 3 × | −2% | 22% | 4% | 2% |
| | | | | 1 h | | | | |

As can be seen in table 10, the degree of grinding and thus the dewatering of the groundwood hardly changes due to the extraction, which has the advantage with regard to possible further processing (for example, into cardboard) that existing production plants do not have to be retooled or converted. The stiffness index also changes only slightly due to the extraction, whereas the tensile index as a measure of the breaking strength increases strongly and reproducibly. Compared to this high increase on average between 20 and 41%, the mass loss due to the evaporation residue of the extract is very low at around 2%. This means that the wood particles gain disproportionately high strength through extraction with little mass loss, which is of great importance especially for the lightweighting trend in the packaging sector.

### Test 8: Purification of the Extracted Extractives

In this test, mechanically dehydrated wood pulp (about 25 wt. % DSC; about 95% spruce and 5% fir) was extracted with a solids: extractant ratio of 1:10 w/w at 50° C. for 1 hour in an autoclave, wherein the extractant was composed of 70 wt. % acetone and 30 wt. % demineralised water. After extraction, the groundwood pulp was pressed out (to about 30 wt. %) and the extract thus obtained was worked up as follows: First, the acetone was separated by distillation by heating the distillation flask to 108° C. and distilling under atmospheric pressure until equilibrium was reached. The remaining residue was centrifuged at 7197 g for 10 minutes and then the sediment was separated from the supernatant. The supernatant was weighed and its dry substance content determined by gentle drying at room temperature, which corresponds fundamentally to the extracted extractives content. The sediment was also weighed and dissolved in a defined mass of pure acetone. The dry substance content of this was determined analogously to the supernatant. The sediment already precipitated during distillation was also dissolved in pure acetone. The dry substance content was determined analogously to the sediment. From the extract, the supernatant, the sediment dissolved in acetone and the deposits dissolved in acetone, the content of free fatty acids (linolenic acid, linoleic acid, oleic acid and stearic acid, each expressed in linoleic acid equivalents), resin acids (isopimaric acid, palustric acid, dehydroabietic acid and abietic acid, each expressed in abietic acid equivalents) and lignans (isolariciresinol, secoisolariciresinol, conidendric acid, hydroxymatairesinol and matairesinol, each expressed in hydroxymatairesinol equivalents) was determined by means of gas chromatography. The results of test 1 and test 2 (repetitions with the same parameters) are listed in Tables 11 and 12.

TABLE 11

| | Extract | | Deposits | | Supernatant | | Sediment | |
|---|---|---|---|---|---|---|---|---|
| | Mean | | Mean | | Mean | | Mean | |
| Test 1 | value | STDEV | value | STDEV | value | STDEV | value | STDEV |
| Mass in g | 439.8 | — | 2.1 | — | 75.4 | — | 1.0 | — |
| DSC in wt. % | 0.2 | 0.0 | 5.0 | — | 0.3 | — | 52.0 | — |
| Content of free | 3.2 | 0.2 | 3.0 | 0.4 | 0.2 | 0.0 | 5.0 | 0.2 |
| fatty acids in | | | | | | | | |
| the dry matter | | | | | | | | |
| in wt. g | | | | | | | | |
| Content of resin | 10.2 | 0.9 | 10.1 | 1.3 | 0.6 | 0.0 | 17.6 | 2.0 |
| acids in the | | | | | | | | |
| dry matter | | | | | | | | |
| in wt. g | | | | | | | | |
| Content of lignans | 13.1 | 1.0 | 0.6 | 0.3 | 36.1 | 1.3 | 0.0 | 0.0 |
| in the dry | | | | | | | | |
| matter in wt. % | | | | | | | | |

TABLE 12

| | Extract | | Deposits | | Supernatant | | Sediment | |
|---|---|---|---|---|---|---|---|---|
| | Mean | | Mean | | Mean | | Mean | |
| Test 2 | value | STDEV | value | STDEV | value | STDEV | value | STDEV |
| Mass in g | 433.7 | — | 1.3 | — | 77.3 | — | 1.3 | — |
| DSC in wt. % | 0.2 | 0.0 | 7.8 | — | 0.3 | — | 40.3 | — |
| Content of free | 3.2 | 0.2 | 3.0 | 0.4 | 0.3 | 0.0 | 4.3 | 0.6 |
| fatty acids in | | | | | | | | |
| the dry matter | | | | | | | | |
| in wt. % | | | | | | | | |
| Content of resin | 10.2 | 0.9 | 9.6 | 1.0 | 0.8 | 0.1 | 13.9 | 2.2 |
| acids in the dry | | | | | | | | |
| matter in wt. % | | | | | | | | |
| Content of lignans | 13.1 | 1.0 | 0.2 | 0.2 | 34.9 | 2.2 | 0.0 | 0.0 |
| in the dry | | | | | | | | |
| matter in wt. % | | | | | | | | |

As can be seen in Tables 11 and 12, the majority of the extractive mass accumulates as centrifuged sediment. Despite the reduction of the amount of liquid by about 80% (from extract to supernatant), the dry substance content (which corresponds substantially to the extractive mass here) in the supernatant is only at a similarly low level as in the extract (<1 wt. %) due to the selected separation methods. However, in the supernatant the content of free fatty acids and resin acids could be reduced to a very low level, whereas the lignans were enriched. In contrast, there are little to no lignans in the sediment and the deposits, but a high content of free fatty acids and resin acids. Although the extractives analysed here (free fatty acids, resin acids and lignans) represent only a part of the extractives (and dry substance found here), it is clearly evident that with the selected thermal and mechanical separation method (distillation and centrifugation) not only the liquid phase can be largely freed from fatty and resin acids, but also lipophilic extractives (e.g. fatty acids and resin acids) and hydrophilic extractives (e.g. lignans) can be significantly concentrated and purified as by-products.

### KEY

STDEV=standard deviation
DM=dry substance
DSC=dry substance content

### Preferred Embodiments

In view of the above description of the present invention, the following preferred embodiments of the invention are disclosed herein:

1. A method for producing products based on non-woody biomass as raw material, characterised in that non-woody biomass which contains cellulose, hemicelluloses and lignin and is in the form of particles is subjected to an extraction treatment with an extractant comprising one or more organic solvents in an organic aqueous mixture of the solvent or solvents with water, wherein the content of fatty acids in the particles is reduced by the extraction treatment of the particles with the extractant by at least 70%, measured as hexanal content in wt. % after accelerated ageing for 72 hours at 90° C., but the content of cellulose, hemicelluloses and lignin is substantially preserved in this extraction treatment.

2. The method according to embodiment 1, characterised in that the particles are in a size of at most 2 mm, wherein the particle size is preferably defined according to the National Renewable Energy Laboratory (NREL) Laboratory Analytical Procedure (LAP) NREL/TP-510-42620 “Preparation of Samples for Compositional Analysis” by the sieve mesh size of 2 mm of the granulator for sample preparation.

3. The method according to embodiment 1 or 2, characterised in that the particles are in the form of fibres, swarf or mixtures thereof.

4. The method according to one or more of embodiments 1 to 3, characterised in that the particles are biomass defibrated by mechanical and/or thermal and/or chemical digestion.

5. The method according to one or more of embodiments 1 to 4, characterised in that the particles are biomass fibres with average fibre lengths between 0.5 and 2 mm and average fibre diameters between 10 and 50 μm, wherein the average fibre length as well as the average fibre diameter refer to the length average determined by means of optical measurement of the suspended fibres.

6. The method according to one or more of embodiments 1 to 5, characterised in that the solvent fraction of the organic aqueous solvent mixture in the extractant, determined as the concentration of the liquid phase of the extract, consists of 0-95 wt. % ethanol, preferably 50-90 wt. % ethanol, 0-99 wt. % acetone, preferably 30-90 wt. % acetone, 0-70 wt. % n-propanol, 0-85 wt. % iso-propanol and/or 0-99 wt. % methanol.

7. The method according to one or more of embodiments 1 to 6, characterised in that the ratio of extractant to solid dry substance is 5:1-25:1 (w/w), preferably 8:1-17:1 (w/w).

8. The method according to one or more of embodiments 1 to 7, characterised in that the extraction treatment is carried out at an extraction temperature of 20-150° C., preferably 40-120° C., in particular 50-110° C.

9. The method according to one or more of embodiments 1 to 8, characterised in that the extraction treatment is carried out at an absolute extraction pressure of 1-5 bar, preferably 1-1.49 bar.

10. The method according to one or more of embodiments 1 to 9, characterised in that the extraction treatment is carried out during an extraction time of 10 minutes-8 hours, preferably 30 minutes-7 hours, in particular 1-5 hours.

11. The method according to one or more of embodiments 1 to 10, characterised in that the method is used for producing cardboard, paper, in particular fibreboard, chipboard, insulating materials, articles of daily use, medical devices, food additives, pharmaceutical additives, such as excipients.

12. The method according to one or more of embodiments 1 to 11, characterised in that the extraction treatment is selected from:
treatment with ethanol in a concentration of at least 65 wt. % at least 65° C. for a period of at least 3 h;
treatment with ethanol in a concentration of at least 65 wt. % at least 85° C. for a period of at least 30 min;
treatment with ethanol in a concentration of at least 70 wt. % at least 105° C. for a period of at least 30 min;
treatment with ethanol in a concentration of at least 45 wt. % at least 105° C. for a period of at least 5 h;
treatment with acetone in a concentration of at least 50 wt. % at least 40° C. for a period of at least 30 min; or
treatment with acetone in a concentration of at least 50 wt. % at least 20° C. for a period of at least 15 min.

13. The method according to one or more of embodiments 1 to 12, characterised in that the treatment with the extractant is carried out as a batch, continuous or semi-continuous extraction, preferably with a partial residence time of at most 1 h per extraction step.

14. The method according to one or more of embodiments 1 to 13, characterised in that, during the extraction treatment, the content of cellulose, hemicelluloses and lignin is reduced by less than 10%, preferably by less than 58, in particular by less than 4%, wherein this reduction is preferably determined as extracted solid mass, in relation to the starting material, the particles.

15. The method according to one or more of embodiments 1 to 14, characterised in that the particles are selected from cereal particles, legume particles, oil plant particles, fibre plant particles, grass particles, in particular miscanthus particles, Jerusalem artichoke particles, reed particles, shrub cuttings particles, leaf particles of trees and shrubs, bark particles, elephant grass particles, hay particles, corncob particles, or mixtures thereof.

16. The method according to one or more of embodiments 1 to 15, characterised in that the particles are mixed with the extractant during the treatment.

17. The method according to one or more of embodiments 1 to 16, characterised in that the particles are pressed out after treatment with the extractant to remove the extractant.

18. The method according to one or more of embodiments 1 to 17, characterised in that, after treatment with the extractant, the particles are purified one or more times with an extractant, preferably with an organic aqueous solvent having a similar or the same concentration as that of the extractant.

19. The method according to one or more of embodiments 1 to 18, characterised in that the extractant is removed from the particles by washing once or several times with water and/or steam stripping and/or drying, preferably by steam stripping and/or drying.

20. The method according to one or more of embodiments 1 to 19, characterised in that the content of fatty acids in the particles is reduced by at least 75%, preferably by at least 80%, in particular by at least 90%, measured as hexanal content in wt. % of the particles in the starting material compared to the extracted particles after accelerated ageing for 72 hours at 90° C., by extraction of the particles with the extractant.

21. The method according to one or more of embodiments 1 to 20, characterised in that the content of fatty acids in the particles is reduced by extraction of the particles with the extractant to a content of less than 2 mg/kg dry substance, preferably of less than 1 mg/kg dry substance, in particular of less than 0.5 mg/kg dry substance, measured as hexanal content as mass fraction of the extracted particles after accelerated ageing for 72 hours at 90° C.

22. The method according to one or more of embodiments 1 to 21, characterised in that, besides the fatty acids, terpenes are also extracted by means of the extraction.

23. The method according to one or more of embodiments 1 to 22, characterised in that the fatty acids, terpenes, pinenes and/or optionally further extractives extracted with the extractant are fed to a further purification process, preferably by mechanical separation technique after thermal separation of the organic solvent from the organic aqueous extractant, wherein lipophilic extractives, in particular fatty acids and resin acids, are precipitated and separated, and an aqueous phase enriched with hydrophilic extractives, in particular lignans, is obtained, wherein preferably the hydrophilic extractives are further concentrated by subsequent treatment with thermal separation technology, in particular by means of membrane separation methods and/or adsorption.

24. The method according to embodiment 23, characterised in that a preceding membrane filtration of the extractant takes place during the extractive enrichment.

25. The method according to one or more of embodiments 1 to 24, characterised in that no complexing agents, in particular selected from polyvalent and polyfunctional complexing agents carboxylic acids, aminomethyl carboxylic acids, aminomethyl phosphonic acids and their compounds, EDTA, DTPA, EGTA, EDDS and their salts, polyphenols, tannins, amino acids, peptides, proteins, polycarboxylates, phosphates, polyphosphates, phosphonic acids, polyphosphonates, phosphated, phosphonylated, sulphated and sulphonated polymers, are added to the particles during the course of the extraction process, in particular during the course of the entire production process for the products produced from the particles.

26. The method according to one or more of embodiments 1 to 25, characterised in that the extractant and also any washing liquids used, in particular water, are regenerated for reuse.

27. The method according to one or more of embodiments 1 to 26, characterised in that, in addition to reducing the hexanal content, the extraction treatment also increases the mechanical strength of the extracted particles, measured as tensile index of sample sheets in Nm/g, by at least 10%, preferably by at least 15%, in particular by at least 25%, %, wherein the degree of grinding, measured in ° SR, changes by less than 10%.

28. The method according to one or more of embodiments 1 to 27, characterised in that the organic aqueous mixture of the solvent (s) contains at least 10% water, preferably at least 7.5% water, in particular at least 5% water.

29. Use of the lipophilic extractive fraction obtained according to embodiments 23 and 24 as an animal feed supplement.

30. The method according to one or more of embodiments 1 to 22 and 25 to 28 for producing products based on wood as raw material, wherein wood in the form of wood particles is used as starting material—instead of the non-woody biomass which contains cellulose, hemicelluloses and lignin—and wherein the fatty acids, terpenes, pinenes and/or optionally further extractives extracted with the extractant are fed to a further purification process, namely by mechanical separation technique after thermal separation of the organic solvent from the organic aqueous extractant, wherein lipophilic extractives, in particular fatty acids and resin acids, are precipitated and separated, and an aqueous phase enriched with hydrophilic extractives, in particular lignans, is obtained, wherein preferably the hydrophilic extractives are further concentrated by subsequent treatment with a thermal separation technique, in particular by means of a membrane separation method and/or adsorption.

31. The method according to embodiment 30, characterised in that a preceding membrane filtration of the extractant takes place during the extractive enrichment.

32. The method according to embodiment 30 or 31, characterised in that the wood particles are selected from softwood particles, preferably spruce wood particles, fir wood particles, pine wood particles, or larch wood particles; hardwood particles, in particular beech wood particles, poplar wood particles, birch wood particles, or eucalyptus wood particles; or mixtures thereof.

33. Use of the lipophilic extractive fraction obtained according to one or more of embodiments 30 to 33 as an animal feed supplement.

Further preferred embodiments of the present invention are the following embodiments:

1. A method for producing products based on non-woody biomass as raw material, characterised in that non-woody biomass which contains cellulose, hemicelluloses and lignin and is in the form of particles is subjected to an extraction treatment with an extractant comprising one or more organic solvents in an organic aqueous mixture of the solvent or solvents with water, wherein the content of fatty acids in the particles is reduced by the extraction treatment of the particles with the extractant by at least 70%, measured as hexanal content in wt. % after accelerated ageing for 72 hours at 90° C., but the content of cellulose, hemicelluloses and lignin is substantially preserved in this extraction treatment.

2. The method according to embodiment 1, characterised in that the particles are present in a size of less than 5 cm, wherein the particle size is preferably determined by sieving by means of a square mesh sieve, in particular by means of a square mesh sieve with a mesh size of 5 cm or less.

3. The method according to embodiment 1 or 2, characterised in that the particles are in the form of fibres, swarf, strands, wood chips or mixtures thereof.

4. The method according to one or more of embodiments 1 to 3, characterised in that the particles are biomass defibrated by mechanical and/or thermal and/or chemical digestion.

5. The method according to one or more of embodiments 1 to 4, characterised in that the particles are biomass fibres with average fibre lengths between 0.5 and 2 mm and average fibre diameters between 10 and 50 μm, wherein the average fibre length as well as the average fibre diameter refer to the length average determined by means of optical measurement of the suspended fibres.

6. The method according to one or more of embodiments 1 to 5, characterised in that the solvent fraction of the organic aqueous solvent mixture in the extractant, determined as the concentration of the liquid phase of the extract, consists of 0-95 wt. % ethanol, preferably 50-90 wt. % ethanol, 0-99 wt. % acetone, preferably 30-90 wt. % acetone, 0-70 wt. % n-propanol, 0-85 wt. % iso-propanol and/or 0-99 wt. % methanol.

7. The method according to one or more of embodiments 1 to 6, characterised in that the ratio of extractant to solid dry substance is 5:1-25:1 (w/w), preferably 8:1-17:1 (w/w).

8. The method according to one or more of embodiments 1 to 7, characterised in that the extraction treatment is carried out at an extraction temperature of 20-150° C., preferably 40-120° C., in particular 50-110° C.

9. The method according to one or more of embodiments 1 to 8, characterised in that the extraction treatment is carried out at an absolute extraction pressure of 1-5 bar, preferably 1-1.49 bar.

10. The method according to one or more of embodiments 1 to 9, characterised in that the extraction treatment is carried out during an extraction time of 10 minutes-8 hours, preferably 30 minutes-7 hours, in particular 1-5 hours.

11. The method according to one or more of embodiments 1 to 10, characterised in that the method is used for producing cardboard, paper, in particular fibreboard, chipboard, insulating materials, articles of daily use, medical devices, food additives, pharmaceutical additives, such as excipients, in particular for producing cardboard.

12. The method according to one or more of embodiments 1 to 11, characterised in that the extraction treatment is selected from:
treatment with ethanol in a concentration of at least 65 wt. % at least 65° C. for a period of at least 3 h;
treatment with ethanol in a concentration of at least 65 wt. % at least 85° C. for a period of at least 30 min;
treatment with ethanol in a concentration of at least 70 wt. % at least 105° C. for a period of at least 30 min;
treatment with ethanol in a concentration of at least 45 wt. % at least 105° C. for a period of at least 5 h;
treatment with acetone in a concentration of at least 50 wt. % at least 40° C. for a period of at least 30 min.

13. The method according to one or more of embodiments 1 to 12, characterised in that the treatment with the extractant is carried out as a batch, continuous or semi-continuous extraction, preferably with a partial residence time of at most 1 h per extraction step.

14. The method according to one or more of embodiments 1 to 13, characterised in that, during the extraction treatment, the content of cellulose, hemicelluloses and lignin is reduced by less than 10%, preferably by less than 58, in particular by less than 4%, wherein this reduction is preferably determined as extracted solid mass, in relation to the starting material, the particles.

15. The method according to one or more of embodiments 1 to 14, characterised in that the particles are selected from cereal particles, legume particles, oil plant particles, fibre plant particles, grass particles, in particular miscanthus particles, Jerusalem artichoke particles, reed particles, shrub cuttings particles, leaf particles of trees and shrubs, bark particles, elephant grass particles, hay particles, corncob particles, or mixtures thereof.

16. The method according to one or more of embodiments 1 to 15, characterised in that the particles are mixed with the extractant during the treatment.

17. The method according to one or more of embodiments 1 to 16, characterised in that the particles are pressed out after treatment with the extractant to remove the extractant.

18. The method according to one or more of embodiments 1 to 17, characterised in that, after treatment with the extractant, the particles are purified one or more times with an extractant, preferably with an organic aqueous solvent having a similar or the same concentration as that of the extractant.

19. The method according to one or more of embodiments 1 to 18, characterised in that the extractant is removed from the particles by washing once or several times with water or drying, preferably by drying.

20. The method according to one or more of embodiments 1 to 19, characterised in that the content of fatty acids in the particles is reduced by at least 75%, preferably by at least 80%, in particular by at least 90%, measured as hexanal content in wt. % of the particles in the starting material compared to the extracted particles after accelerated ageing for 72 hours at 90° C., by extraction of the particles with the extractant.

21. The method according to one or more of embodiments 1 to 20, characterised in that the content of fatty acids in the particles is reduced by extraction of the particles with the extractant to a content of less than 2 mg/kg dry substance, preferably of less than 1 mg/kg dry substance, in particular of less than 0.5 mg/kg dry substance, measured as hexanal content as mass fraction of the extracted particles after accelerated ageing for 72 hours at 90° C.

22. The method according to one or more of embodiments 1 to 21, characterised in that, besides the fatty acids, terpenes are also extracted by means of the extraction.

23. The method according to one or more of embodiments 1 to 22, characterised in that the fatty acids, terpenes, pinenes and/or optionally further extractives extracted with the extractant are fed to a further purification process.

24. The method according to one or more of embodiments 1 to 23, characterised in that no complexing agents, in particular complexing agents selected from polyvalent and polyfunctional carboxylic acids, aminomethyl carboxylic acids, aminomethyl phosphonic acids and their compounds, EDTA, DTPA, EGTA, EDDS and their salts, polyphenols, tannins, amino acids, peptides, proteins, polycarboxylates, phosphates, polyphosphates, phosphonic acids, polyphosphonates, phosphated, sulphated phosphonylated, and sulphonated polymers, are added to the particles during the course of the extraction process, in particular during the course of the entire production process for the products produced from the particles.

25. The method according to one or more of embodiments 1 to 24, characterised in that the extractant and also any washing liquids used, in particular water, are regenerated for reuse.

26. The method according to one or more of embodiments 1 to 25, characterised in that, in addition to reducing the hexanal content, the extraction treatment also increases the mechanical strength of the extracted particles, measured as tensile index of sample sheets in Nm/g, by at least 10%, preferably by at least 15%, in particular by at least 25%, %, wherein the degree of grinding, measured in ° SR, changes by less than 10%.

1. A method for producing products based on non woody biomass as raw material, characterised in that non woody biomass which contains cellulose, hemicelluloses and lignin and is in the form of particles is subjected to an extraction treatment with an extractant comprising one or more organic solvents in an organic aqueous mixture of the solvent or solvents with water, wherein the content of fatty acids in the particles is reduced by the extraction treatment of the particles with the extractant by at least 70%, measured as hexanal content in wt. % after accelerated ageing for 72 hours at 90° C., but the content of cellulose, hemicelluloses and lignin is substantially preserved in this extraction treatment.

2. The method according to claim 1, characterised in that the particles are in a size of at most 2 mm, wherein the particle size is preferably defined according to the National Renewable Energy Laboratory (NREL) Laboratory Analytical Procedure (LAP) NREL/TP 510 42620 “Preparation of Samples for Compositional Analysis” by the sieve mesh size of 2 mm of the granulator for sample preparation, wherein the particles are preferably in the form of fibres, swarf or mixtures thereof.

3. The method according to claim 1, characterised in that the particles are biomass defibrated by mechanical and/or thermal and/or chemical digestion, in particular biomass fibres with average fibre lengths between 0.5 and 2 mm and average fibre diameters between 10 and 50 μm, wherein the average fibre length as well as the average fibre diameter refer to the length average determined by means of optical measurement of the suspended fibres.

4. The method according to claim 1, characterised in that the solvent fraction of the organic aqueous solvent mixture in the extractant, determined as the concentration of the liquid phase of the extract, consists of 0 95 wt. % ethanol, preferably 50 90 wt. % ethanol, 0 99 wt. % acetone, preferably 30 90 wt. % acetone, 0 70 wt. % n propanol, 0 85 wt. % iso propanol and/or 0 99 wt. % methanol.

5. The method according to claim 1, characterised in that during the extraction treatment, the content of cellulose, hemicelluloses and lignin is reduced by less than 10%, preferably by less than 5%, in particular by less than 4%, wherein this reduction is preferably determined as extracted solid mass, in relation to the starting material, the particles.

6. The method according to claim 1, characterised in that the particles are selected from cereal particles, legume particles, oil plant particles, fibre plant particles, grass particles, in particular miscanthus particles, Jerusalem artichoke particles, reed particles, shrub cuttings particles, leaf particles of trees and shrubs, bark particles, elephant grass particles, hay particles, corncob particles, or mixtures thereof.

7. The method according to claim 1, characterised in that, after treatment with the extractant, the particles are purified one or more times with an extractant, preferably with an organic aqueous solvent having a similar or the same concentration as that of the extractant.

8. The method according to claim 1, characterised in that the content of fatty acids in the particles is reduced by at least 75%, preferably by at least 80%, in particular by at least 90%, measured as hexanal content in wt. % of the particles in the starting material compared to the extracted particles after accelerated ageing for 72 hours at 90° C., by extraction of the particles with the extractant.

9. The method according to claim 1, characterised in that the content of fatty acids in the particles is reduced by extraction of the particles with the extractant to a content of less than 2 mg/kg dry substance, preferably of less than 1 mg/kg dry substance, in particular of less than 0.5 mg/kg dry substance, measured as hexanal content as mass fraction of the extracted particles after accelerated ageing for 72 hours at 90° C.

10. The method according to claim 1, characterised in that, besides the fatty acids, terpenes are also extracted by means of the extraction.

11. The method according to claim 1, characterised in that the fatty acids, terpenes, pinenes and/or optionally further extractives extracted with the extractant are fed to a further purification process, preferably by mechanical separation technique after thermal separation of the organic solvent from the organic aqueous extractant, wherein lipophilic extractives, in particular fatty acids and resin acids, are precipitated and separated, and an aqueous phase enriched with hydrophilic extractives, in particular lignans, is obtained, wherein preferably the hydrophilic extractives are further concentrated by subsequent treatment with thermal separation technology, in particular by means of membrane separation methods and/or adsorption.

12. The method according to claim 11, characterised in that a preceding membrane filtration of the extractant takes place during the extractive enrichment.

13. The method according to claim 1, characterised in that no complexing agents, in particular complexing agents selected from polyvalent and polyfunctional carboxylic acids, aminomethyl carboxylic acids, aminomethyl phosphonic acids and their compounds, EDTA, DTPA, EGTA, EDDS and their salts, polyphenols, tannins, amino acids, peptides, proteins, polycarboxylates, phosphates, polyphosphates, phosphonic acids, polyphosphonates, phosphated, phosphonylated, sulphated and sulphonated polymers, are added to the particles during the course of the extraction process, in particular during the course of the entire production process for the products produced from the particles.

14. The method according to claim 1, characterised in that the extractant and also any washing liquids used, in particular water, are regenerated for reuse.

15. The method according to claim 1, characterised in that, in addition to reducing the hexanal content, the extraction treatment also increases the mechanical strength of the extracted particles, measured as tensile index of sample sheets in Nm/g, by at least 10%, preferably by at least 15%, in particular by at least 25%, %, wherein the degree of grinding, measured in ° SR, changes by less than 10%.

16. An animal feed supplement comprising Use of the lipophilic extractive fraction obtained according to claim 11.

17. The method according to claim 1 for producing products based on wood as raw material, wherein wood in the form of wood particles is used as starting material instead of the non woody biomass which contains cellulose, hemicelluloses and lignin and wherein the fatty acids, terpenes, pinenes and/or optionally further extractives extracted with the extractant are fed to a further purification process, namely by mechanical separation technique after thermal separation of the organic solvent from the organic aqueous extractant, wherein lipophilic extractives, in particular fatty acids and resin acids, are precipitated and separated, and an aqueous phase enriched with hydrophilic extractives, in particular lignans, is obtained, wherein preferably the hydrophilic extractives are further concentrated by subsequent treatment with a thermal separation technique, in particular by means of a membrane separation method and/or adsorption.

18. The method according to claim 17, characterised in that a preceding membrane filtration of the extractant takes place during the extractive enrichment.

19. The method according to claim 17, characterised in that the wood particles are selected from softwood particles, preferably spruce wood particles, fir wood particles, pine wood particles, or larch wood particles; hardwood particles, in particular beech wood particles, poplar wood particles, birch wood particles, or eucalyptus wood particles; or mixtures thereof.

20. An animal feed supplement comprising the lipophilic extractive fraction obtained according to claim 17.
